(19) United States
(12) Patent Application Publication
(10) Pub. No.: US 2021/0180418 A1
(43) Pub. Date: Jun. 17, 2021

(54) PROSPECTIVE KICK LOSS DETECTION FOR OFF-SHORE DRILLING

(71) Applicant: HALLIBURTON ENERGY SERVICES, INC., Houston, TX (US)

(72) Inventors: Zhijie SUN, Spring, TX (US); Rui REN, Tulsa, OK (US); Robert P. DARBE, Tomball, TX (US); Mathew Dennis ROWE, Spring, TX (US)

(21) Appl. No.: 16/711,739

(22) Filed: Dec. 12, 2019

(51) Int. Cl. E21B 21/08; E21B 47/00; E21B 44/00

(52) U.S. Cl. CPC E21B 21/08; G06F 30/28; E21B 44/00; E21B 47/0001

(57) ABSTRACT

Certain aspects and features relate to a system that monitors for kick and lost circulation in the riser string of an offshore drilling rig. The system compensates for annulus outflow fluctuation induced by wave (heave) motion in order to reduce false alarms, resulting in fewer drilling operation disruptions. The system includes a sensor or sensors disposable with respect to a drilling rig subject to rig motion. A processor receives a real-time position signal indicative of the rig motion from the sensor and applies a state observer to the position signal to determine annular flow parameters. The system models an annular flow for the wellbore to produce a modeled flow signal that reflects a position of the drilling rig relative to influx flow. The system uses the modeled flow to determine kick-loss-alarm parameters that take into account the heave motion.

### TECHNICAL FIELD

The present disclosure relates generally to well systems. More specifically, but not by way of limitation, this disclosure relates to real-time monitoring of kick and loss while drilling a well from a floating vessel.

### BACKGROUND

A hydrocarbon well includes a wellbore drilled through a subterranean formation.

Some wellbores are drilled into a subterranean formation below the seabed. Such a wellbore is typically drilled from a floating vessel, by what is sometimes referred to as an offshore rig. As with terrestrial drilling operations, drilling fluid or mud can be circulated downhole to lubricate and cool the drill bit. A riser string runs around the drillstring from the vessel to the sea floor to contain the drilling fluid as it passes through intervening water. The riser string includes one or more slip joints to accommodate rig motion. Sensors are used to monitor the riser string for stresses and movements that, if allowed to continue, could result in riser string failures or leaks. The sensor data can be used to trigger an alarm, which prompts rig personnel to evaluate the situation and take corrective action if necessary.

Riser string monitoring typically includes sensing for kicks, where a sudden pressure change causes formation fluids to be forced up into the drilling fluid, and loss, where circulating drilling fluid leaves the riser string on its way to and from the drill bit. In certain types of drilling operations, a slip joint in the riser string expands and contracts due to wave motion or tides, causing riser string volume to change as the vessel rises and falls. This changing volume can cause kick and loss circulation false alarms. The drill operator evaluates conditions and determines whether and how to make adjustments based on experience coupled with observation of current conditions when any alarm is triggered.

### BRIEF DESCRIPTION OF THE DRAWINGS

FIG. 1 is a cross-sectional view of an example of a drilling system that includes prospective kick and loss detection according to some aspects of the disclosure.

FIG. 2 is a block diagram of an example of a computing device for prospective kick and loss detection according to some aspects of the disclosure.

FIG. 3 is a flowchart of a process for prospective kick and loss detection according to some aspects of the disclosure.

FIG. 4 is a data flow diagram illustrating the inputs and outputs of a prospective model for prospective kick and loss detection according to some aspects of the disclosure.

FIG. 5 is graphs showing riser position data and its correspondence to filtered velocity data when prospective kick and loss detection is being employed in an offshore rig according to some aspects of the disclosure.

FIG. 6 is graphs comparing various flow differences related to prospective kick and loss detection being employed in an offshore rig according to some aspects of the disclosure.

### DETAILED DESCRIPTION

Certain aspects and features relate to a system that improves, and makes more efficient, the monitoring for kick and lost circulation in the riser string of an offshore rig being used for drilling an undersea wellbore. The system can compensate for annulus outflow fluctuation induced by wave (or heave) motion to reduce false kick and loss alarms, resulting in fewer drilling operation disruptions and less fatigue for rig personnel who respond to the alarms. Certain examples can be more autonomous, reliable, and faster than currently employed methods at compensating annulus return flow variation induced by wave motion and thus increase the kick and loss early-warning accuracy.

In some examples, a system includes a sensor or sensors disposable with respect to a drilling rig subject to rig motion, as well as a computing device that can be communicatively coupled to the sensor. The sensor can be a heave sensor, inclinometer, multi-direction accelerometer or other positional sensor. The computing device can receive a real-time position signal indicative of the rig motion from the sensor and apply a state observer to the position signal to determine annular flow parameters. The computing device can model an annular flow for the wellbore to produce a modeled flow signal based on the annular flow parameters. The modeled flow signal can reflect a predicted position of the drilling rig relative to influx flow. The computing device can use the modeled flow to determine kick-loss-alarm parameters, store the kick-loss-alarm parameters, and apply the kick-loss-alarm parameters to an alarm module. An example of a kick-loss-alarm parameter is an adjusted alarm threshold that accounts for the heave motion. The process can repeat in real time so that the alarm parameters are adjusted continuously based on changing conditions.

In some examples, the annular flow is modeled in part by applying a linear quadratic estimation filter to the position signal to estimate a velocity of the rig motion in a state vector and to estimate an influx flow variation. A gain of the state observer is then optimized based on the velocity of the rig motion and the influx flow variation. The annular flow can be modeled by using a physics-based model or a data-driven model, including a machine-learning model. Optionally, a standard deviation from a statistical distribution of the influx flow variation can be used to calculate a confidence level for the alarm threshold, and this confidence level can be provided to rig personnel on a display device.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

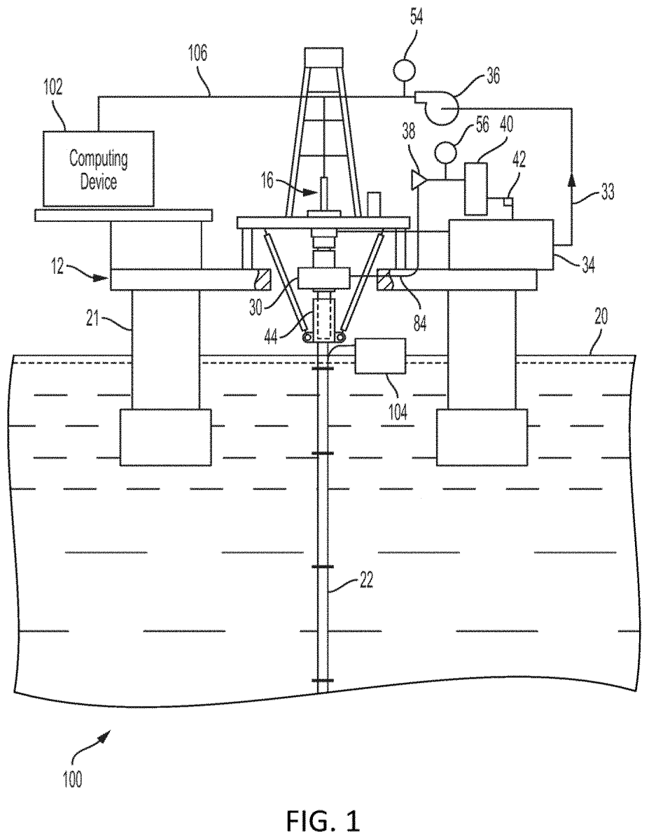

FIG. 1 is a cross-sectional view of an example of a drilling system 100 that includes prospective kick and loss detection according to some aspects of the disclosure. In the system 100 depicted in FIG. 1, a floating rig 12 is used to drill a wellbore. The rig 12 is depicted in FIG. 1 on a floating vessel 21 positioned at a surface location (e.g., at a surface 20 of a deep or ultra-deep body of water). The vessel 21 rises and falls in response to wave action and tides. In the example of FIG. 1, a marine riser string 22, which may also be referred to in an abbreviated way as a riser, extends between the rig 12 and a blowout preventer stack (not shown) positioned at a subsea location near the top of the wellbore. The riser string 22 serves as a conduit for guiding the drillstring 16 between the rig 12 and the sea floor and for flowing drilling fluid between the rig and the wellbore. Near an upper end of the riser string 22 is an annular sealing device 30, which is also designed to seal off the annulus about the drillstring 16 while the drillstring is being used to drill the wellbore.

Still referring to FIG. 1, drilling fluid 33 is contained in a reservoir 34 of the rig 12. A rig pump 36 is used to pump the drilling fluid 33 into the drillstring 16 at the surface. The drilling fluid flows through the drillstring and into the wellbore, exiting the drillstring at the drill bit. The drilling fluid 33 then flows through the annulus back to the reservoir 34 via a choke manifold 38, a gas buster or degasser 40, a solids separator 42, etc. In addition to monitoring for kick and loss, computing device 102 can operate a pressure control system for the wellbore. The pressure control system includes the choke manifold 38, which operates so that a desired amount of backpressure is applied to the annulus. The pressure control system may regulate operation of other equipment (e.g., the pump 36, a standpipe control valve, a diverter, which diverts flow from the pump 36 to a drilling fluid return line 84 upstream of the choke manifold 38, etc.), as well. Pressure can be regulated with the help of readings from flow meter 54 and flow meter 56.

Both kicks and losses are undesirable drilling events that require proper corrective actions by rig personnel before drilling can be safely resumed. The computing device 102 includes computer program code, which may be referred to here in an abbreviated way as instructions. The instructions are executed by processing device 202 to monitor for kicks and losses and produce an alarm signal for rig personnel. The alarm signal can take the form of a message on a display device connected to the computing device, as flashing indicators, as audible alarm signals, or as a combination of these.

Kicks and losses are relatively easy to detect in land-based drilling systems. On a floating vessel, however, detecting kicks and losses is complicated by non-constant returns from the wellbore during the drilling operations, even if the drilling fluid is pumped in at a constant rate. The floating vessel is connected to the riser via a telescoping slip joint, such as telescoping slip joint 44 in FIG. 1. A telescoping slip joint is also known as a sliding joint or a slip joint. The slip joint can accommodate vertical wave-induced motion of the vessel 21 as well as motion from tidal influence. As the slip joint 44 extends and contracts with wave motion, a volume of the annulus between an outer diameter of the drillstring and an inner diameter of the riser string 22 changes. And, flow of drilling fluid 33 from the annulus changes with the motion of the vessel 21 while drilling, even if the pump rate into the drillstring remains constant. Since the volume of the drilling fluid 33 leaving the well is constantly changing, detecting kicks and losses by simply measuring the difference in flow rate between fluid leaving and entering the well becomes problematic. In some systems, a computing device calculates the relationship between the instantaneous change in volume of the annulus and the vertical velocity of the floating vessel 21 and uses this difference to adjust the alarm thresholds. Although using this calculated difference improves kick and loss detection rates, false alarms can occur.

Some features and aspects of the system described in further detail below compensate for annulus outflow fluctuation induced by wave (heave) motion more precisely than by relying only on the difference value to reduce false kick and loss alarms, resulting in fewer drilling operation disruptions and less alarm fatigue for rig personnel. In some examples, computing device 102 receives real-time position or motion values from a sensor 104 via connection 106 and uses the real-time values to model annular flow. In some aspects, sensor 104 can be referred to as a heave motion sensor. A heave motion sensor can take many different forms, including, as examples, a float sensor, a stress gauge, or any one of various kinds of transducers installed in various parts of the rig or vessel.

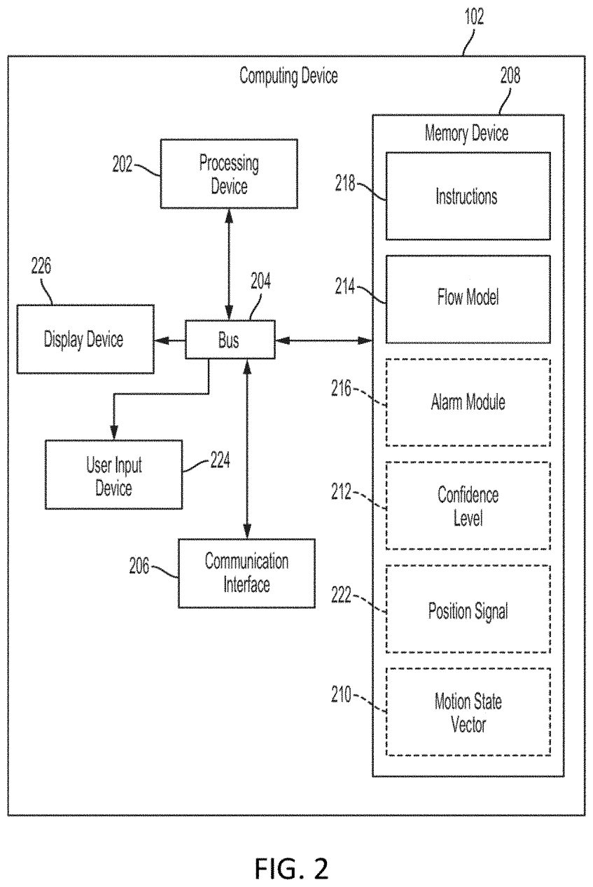

FIG. 2 depicts an example of the computing device 102 according to some aspects. The computing device 102 can include a processing device 202, a bus 204, a communication interface 206, a memory device 208, a user input device 224, and a display device 226. In some examples, the components shown in FIG. 2 can be integrated into a single structure. For example, the components can be within a single housing with a single processing device. In other examples, the components shown in FIG. 2 can be distributed (e.g., in separate housings) and in electrical communication with each other using various processors. It is also possible for the components to be distributed in a cloud computing system or grid computing system.

The processing device 202 can execute one or more operations for prospective kick and loss detection applied to the riser string 22 of the vessel 21 of offshore rig 12. The processing device 202 can execute instructions 218 stored in the memory device 208 to perform the operations. The processing device 202 can include one processing device or multiple processing devices. Non-limiting examples of the processing device 202 include a field-programmable gate array (“FPGA”), an application-specific integrated circuit (“ASIC”), a processor, a microprocessor, etc.

The processing device 202 is communicatively coupled to the memory device 208 via the bus 204. The non-volatile memory device 208 may include any type of memory device that retains stored information when powered off. Non-limiting examples of the memory device 208 include electrically erasable and programmable read-only memory (“EEPROM”), flash memory, or any other type of non-volatile memory. In some examples, at least some of the memory device 208 can include a non-transitory medium from which the processing device 202 can read instructions. A computer-readable medium can include electronic, optical, magnetic, or other storage devices capable of providing the processing device 202 with computer-readable instructions or other program code. Non-limiting examples of a computer-readable medium include (but are not limited to) magnetic disk(s), memory chip(s), read-only memory (ROM), random-access memory (“RAM”), an ASIC, a configured processing device, optical storage, or any other medium from which a computer processing device can read instructions. The instructions can include processing device-specific instructions generated by a compiler or an interpreter from code written in any suitable computer-programming language, including, for example, C, C++, C #, etc.

In some examples, the memory device 208 can include a current motion state vector 210 and buffered position signal data 222 from sensor 104 or other sensors. In some examples, the memory device 208 includes the computer program code instructions 218 for monitoring for kick and loss and providing alarm indications using alarm module 216, which may include alarm threshold values and any other stored information and additional computer program code necessary to produce kick and loss alarms. Alarms are provided using an annular flow model 214, which may be a physics-based model or a data-driven model such as a machine-learning model. Some or all of these alarms may be provided with a confidence level 212, which can optionally be calculated by the processing device 202 executing instructions 218.

In some examples, the computing device 102 includes a communication interface 206. The communication interface 206 can represent one or more components that facilitate a network connection or otherwise facilitate communication between electronic devices. Examples include, but are not limited to, wired interfaces such as Ethernet, USB, IEEE 1394, and/or wireless interfaces such as IEEE 802.11, Bluetooth, near-field communication (NFC) interfaces, RFID interfaces, or radio interfaces for accessing cellular telephone networks (e.g., transceiver/antenna for accessing a CDMA, GSM, UMTS, or other mobile communications network). In some examples, the computing device 112 includes a user input device 224. The user input device 224 can represent one or more components used to input data. Examples of the user input device 224 can include a keyboard, mouse, touchpad, button, or touch-screen display, etc. In some examples, the computing device 112 includes a display device 226. The display device 226 can represent one or more components used to output data. Examples of the display device 226 can include a liquid-crystal display (LCD), a computer monitor, a touch-screen display, etc. In some examples, the user input device 224 and the display device 226 can be a single device, such as a touch-screen display. The display device can be used to display alarms and confidence levels as described herein.

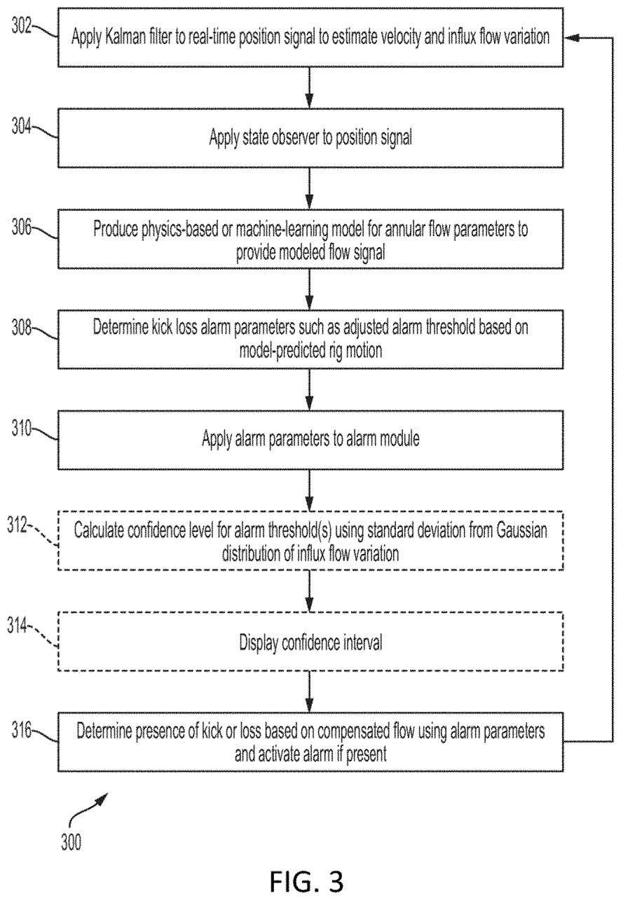

FIG. 3 is an example of a flowchart of a process 300 for prospective kick and loss detection according to at least some aspects of the disclosure. At block 302, processing device 202 applies a linear quadratic estimation filter to a real-time position signal coming from the sensor in order to estimate velocity and influx flow variation. In this example, the filter is a Kalman filter. At block 304, processing device 202 applies a state observer to the position signal coming from the sensor. At block 306, processing device 202 produces a model for annular flow parameters in order to provide a modeled flow signal. The model can be a predetermined, stored, physics-based model, or a machine-learning model that adapts in real time. At block 308, the computing device determines kick-loss-alarm parameters such as an adjusted alarm threshold. These parameters are determined based on rig motion predicted by the model produced in block 306. At block 310, processing device 202 applies the alarm parameters to alarm module 216 in memory device 208.

Still referring to FIG. 3, optionally, at block 312, processing device 202 calculates a confidence level for any alarm thresholds using the standard deviation from a statistical distribution of influx flow variation. In this example a Gaussian distribution is used. Optionally, at block 314, the confidence level can be displayed to rig personnel, for example, on display device 226. The confidence level can be displayed continuously, or can be displayed during an alarm condition so that rig personnel are aware of the likelihood that the alarm is genuine. At block 316 of FIG. 3, the computing device determines the presence of kick, lost circulation (loss), or both based on the compensated flow using the alarm parameters. The computing device activates the alarm if kick or loss is present. Process 300 of FIG. 3 can repeat so that accurate monitoring occurs over time. For purposes of the discussion herein, a reference to kick, loss, kick loss, etc., can refer to either kick, loss, or combination of the two.

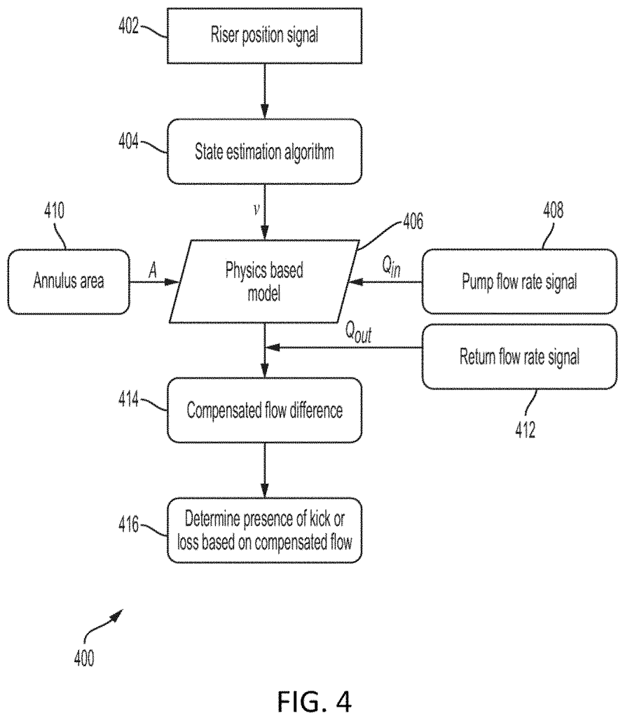

FIG. 4 is a data flow diagram 400 illustrating the inputs and outputs of a model for prospective kick and loss detection according to some aspects of the disclosure. For purposes of illustration, a physics-based model is shown. A data-driven or machine-learning model can also be used and is discussed below. In terms of the pumping effect of the telescope joint for annulus fluid return, based on mass conservation, a physics-based model can be built according to:

$$A \frac{\partial h}{\partial t} + {Q}_{i n} = {Q}_{out} ,$$

where A is the annular area between riser and drillstring, ft²; h is the riser position, ft; t is time, sec; Qᵢₙ is the pump flow rate, gpm; and Qₒᵤₜ is the annulus outflow rate, gpm. In this example, a heave motion sensor is used to measure riser position, h, corresponding to wave-induced float rig motion. The heave motion can be represented by the following equation of motion:

x(k+1)=Fx(k),

z(k)=Hx(k)

where, k is the current time step, and k+1 is the next time step; x=[h, v, a]^{T} is the state vector; h, v, a are position, velocity and acceleration of riser position, respectively; z=h is the output of the model; F is state transition matrix:

$$F = [ \begin{matrix}1 & Δ t & \frac{1}{2} Δ {t}^{2} \\ 0 & 1 & Δ t \\ 0 & 0 & 1\end{matrix} ] ,$$

and H is the measurement matrix:

H=[1 0 0]^{T}.

In order to determine the unmeasured velocity v in the state vector x, state estimation techniques can be applied. Generally, state estimation is performed by building a state observer for the model as given by:

\hat{x}(k+1)=F\hat{x}(k)+L(k)[y(k)—ŷ(k)]

ŷ(k)=H\hat{x}(k)

where L(k) is the observer gain to be determined. The optimal value of observer gain L(k) can be determined by the following Kalman filtering technique, where optimal is defined as minimum mean squared error (MMSE) between the state estimation \hat{x} and the state vector x. A common approach to using Kalman filtering is shown by:

\hat{x}(k+1)=F\hat{x}(k)

P(k+1)=FP(k)F^{T}+Q

for the prediction update and:

y(k)=z(k)−Hx(k)

K=P(k+1)H^{T}(HP(k+1)H^{T}+R)⁻¹

x(k+1)=x(k)+Ky(k)

P(k+1)=(l−Ky(k))P(k),

where \hat{x}(k) is the estimate of x(k); y(k) is the residual; z(k) is the measured riser position; P(k) is the uncertainty matrix; K is the Kalman gain; and Q and R are the pre-determined covariance matrices of process noise and measurement noise respectively.

This detailed procedure is shown in FIG. 4, where riser position signal 402 is indicative of rig motion is supplied to state estimation algorithm 404, which supplied velocity v to physic-based model 406. The model also uses the pump flow rate signal 408 and the annulus area 410. Using the velocity from Kalman filtering and feeding it to the physics model, the equilibrium equation for a no-lost-circulation scenario can be calculated, and the variation of the annulus return flow rate 412, Qₒᵤₜ can be compensated by providing the compensated flow difference 414. If kick or lost circulation occurs, the equilibrium of the function will be disturbed, and the heave compensation algorithm for the rig cannot compensate the flow difference, which equals Qₒᵤₜ−Qᵢₙ. The difference is the kick or the lost circulation rate:

$$A \frac{\partial h}{\partial t} - Δ Q = δ ,$$

where ΔQ is the flow difference, gpm; and δ is the kick or lost circulation flow rate, gpm. The presence of kick or loss is determined at block 416 based on the compensated flow.

In drilling operations, the drilling pump efficiency can decrease, and annular area A is sometimes unknown. In such a case, the physics-based model can be extended into a data-driven model:

$$A \frac{\partial h}{\partial t} + {Q}_{i n} + B = {Q}_{out} ,$$

where, the A is annular area between riser and drillstring and B is bias term that can quantify the pump efficiency, sensor calibration drift or riser pump influx, etc. In the data-driven approach, both A and B can be learned from real-time data by machine-learning techniques without manually tuning parameters, making the data-driven model a machine-learning model.

A fluid influx (kick) or lost circulation (loss) alarm may also be accompanied by a confidence level. The confidence level of alarm may be calculated based the probability distribution from normal data (i.e., difference of flow rate measured when there is no kick or loss). For example, if the difference of flow rate, δ, follows Gaussian distribution when no kick or loss occurs, then if a new data point is δ(k+1)=2σ where σ is the standard deviation of Gaussian distribution, one may conclude it falls within a 95% confidence interval. Thus, the level indicates there is no kick or loss condition with 95% confidence, or there is a kick or loss condition with 5% confidence. Other statistical distributions can be used. As an example, if the compensated flow difference follows a uniform distribution between −10 gpm and +10 gpm, the alarm can sound with 95% confidence at levels of −9.5 gpm and +9.5 gpm.

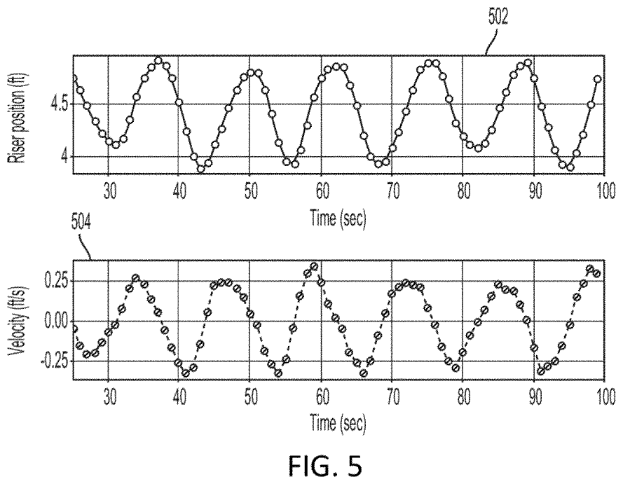

FIG. 5 presents graphs showing riser position and how it corresponds to filter velocity data when prospective kick and loss detection according to aspects of this disclosure is being used. Graph 502 shows riser position measurement and graph 504 shows the velocity output from the Kalman filter. The real time riser position data was measured at an offshore drilling rig. By using Kalman filtering techniques, the hidden parameters (e.g. velocity) can be calculated, and the calculation results are shown in graph 504. When the riser position reaches the peak, the velocity result from the Kalman filter is equal to zero.

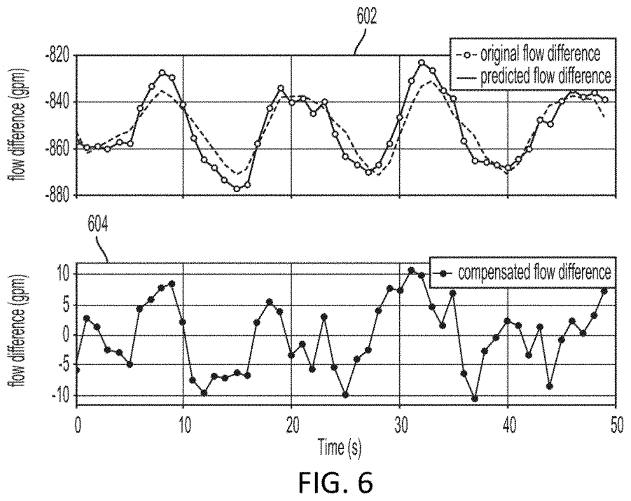

FIG. 6 presents graphs comparing flow differences related to prospective kick and loss detection using a machine-learning model. After self-learning parameters are established by the machine-learning model, the flow difference can be predicted. Graph 602 shows the predicted flow difference and the original flow difference, and the graphed data suggests the machine-learning model can accurately track the trend of flow difference from the measurement data. Additionally, the compensated flow difference is within 10 gpm bound, which means a small flow difference bound can be used to avoid kick and loss false alarms. Graph 604 shows the compensated flow difference.

Terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, steps, operations, elements, or components, but do not preclude the presence or addition of one or more other features, steps, operations, elements, components, or groups thereof. Additionally, comparative, quantitative terms such as “above,” “below,” “less,” and “greater” are intended to encompass the concept of equality, thus, “less” can mean not only “less” in the strictest mathematical sense, but also, “less than or equal to.”

In some aspects, a system for prospective kick and loss detection is provided according to one or more of the following examples. As used below, any reference to a series of examples is to be understood as a reference to each of those examples disjunctively (e.g., “Examples 1-4” is to be understood as “Examples 1, 2, 3, or 4”).

1. A system includes at least one sensor disposable with respect to a drilling rig subject to rig motion, a processor communicatively coupled to the at least one sensor, and a non-transitory memory device comprising instructions that are executable by the processor to cause the processor to perform operations. The operations include receiving, in real time from the at least one sensor, a position signal indicative of the rig motion, applying a state observer to the position signal to determine annular flow parameters, and modeling an annular flow for a wellbore associated with the drilling rig to produce a modeled flow signal based on the annular flow parameters. The modeled flow signal reflects a position of the drilling rig relative to influx flow. The operations further include determining kick-loss-alarm parameters from the modeled flow signal, and applying the kick-loss-alarm parameters to an alarm module.

2. The system of example 1, wherein the at least one sensor includes a heave motion sensor and the rig motion comprises wave-induced rig motion.

3. The system of example(s) 1-2, wherein the operation of modeling the annular flow further includes applying a linear quadratic estimation filter to the position signal to estimate a velocity of the rig motion in a state vector and to estimate an influx flow variation, and optimizing a gain of the state observer based on the velocity of the rig motion and the influx flow variation.

4. The system of example(s) 1-3, wherein the operation of determining the kick-loss-alarm parameters includes adjusting an alarm threshold for at least one of kick or loss based on the rig motion as determined from the modeled flow signal.

5. The system of example(s) 1-4, further comprising a display device, and wherein the operations further includes determining a standard deviation from a statistical distribution of influx flow variation, calculating a confidence level for the alarm threshold based on the standard deviation, and displaying the confidence level on a display device.

6. The system of example(s) 1-5, wherein the operation of modeling the annular flow further includes producing a physics-based model based on a pumping effect of a telescope joint, annulus fluid return, and mass conservation.

7. The system of example(s) 1-6, wherein the operation of modeling the annular flow further includes producing a machine-learning model that determines, based on the position signal over time, an annular area and a bias term quantifying pumping efficiency.

8. A method includes receiving, by a processing device in real time from at least one sensor, a position signal indicative of rig motion, applying, by the processing device, a state observer to the position signal to determine annular flow parameters, and modeling, by the processing device, an annular flow for a wellbore to produce a modeled flow signal based on the annular flow parameters. The modeled flow signal reflects a position of a drilling rig relative to influx flow. The method further includes determining, by the processing device, kick-loss-alarm parameters from the modeled flow signal, and applying, by the processing device, the kick-loss-alarm parameters to an alarm module.

9. The method of example 8, wherein the at least one sensor includes a heave motion sensor and the rig motion comprises wave-induced rig motion.

10. The method of example(s) 8-9, wherein modeling the annular flow further includes applying a linear quadratic estimation filter to the position signal to estimate a velocity of the rig motion in a state vector and to estimate influx flow variation, and optimizing a gain of the state observer based on the velocity of the rig motion and the influx flow variation.

11. The method of example(s) 8-10, wherein determining the kick-loss-alarm parameters includes adjusting an alarm threshold for at least one of kick or loss based on the rig motion as determined from the modeled flow signal.

12. The method of example(s) 8-11 further includes determining a standard deviation from a statistical distribution of influx flow variation, calculating a confidence level for the alarm threshold based on the standard deviation, and displaying the confidence level on a display device.

13. The method of example(s) 8-12, wherein modeling the annular flow further includes producing a physics-based model based on a pumping effect of a telescope joint, annulus fluid return, and mass conservation.

14. The method of example(s) 8-13, wherein modeling the annular flow further includes producing a machine-learning model that determines, based on the position signal over time, an annular area and a bias term quantifying pumping efficiency.

15. A non-transitory computer-readable medium includes instructions that are executable by a processor for causing the processor to perform operations related to kick and loss detection. The operations include receiving, in real time from at least one sensor, a position signal indicative of rig motion, applying a state observer to the position signal to determine annular flow parameters, and modeling an annular flow for a wellbore to produce a modeled flow signal based on the annular flow parameters. The modeled flow signal reflects a position of a drilling rig relative to influx flow. The operations further include determining kick-loss-alarm parameters from the modeled flow signal, and applying the kick-loss-alarm parameters to an alarm module.

16. The non-transitory computer-readable medium of example 15, wherein the operation of modeling the annular flow further includes applying a linear quadratic estimation filter to the position signal to estimate a velocity of the rig motion in a state vector and to estimate an influx flow variation, and optimizing a gain of the state observer based on the velocity of the rig motion and the influx flow variation.

17. The non-transitory computer-readable medium of example(s) 15-16, wherein the operation of determining the kick-loss-alarm parameters includes adjusting an alarm threshold for at least one of kick or loss based on the rig motion as determined from the modeled flow signal.

18. The non-transitory computer-readable medium of example(s) 15-17, wherein the operations further include determining a standard deviation from a statistical distribution of influx flow variation, calculating a confidence level for the alarm threshold based on the standard deviation, and displaying the confidence level on a display device.

19. The non-transitory computer-readable medium of example(s) 15-18, wherein the operation of modeling the annular flow further includes producing a physics-based model based on a pumping effect of a telescope joint, annulus fluid return, and mass conservation.

20. The non-transitory computer-readable medium of example(s) 15-19, wherein operation of modeling the annular flow further includes producing a machine-learning model that determines, based on the position signal over time, an annular area and a bias term quantifying pumping efficiency.

The foregoing description of the examples, including illustrated examples, has been presented only for the purpose of illustration and description and is not intended to be exhaustive or to limit the subject matter to the precise forms disclosed. Numerous modifications, combinations, adaptations, uses, and installations thereof can be apparent to those skilled in the art without departing from the scope of this disclosure. The illustrative examples described above are given to introduce the reader to the general subject matter discussed here and are not intended to limit the scope of the disclosed concepts.

What is claimed is:

1. A system comprising:
at least one sensor disposable with respect to a drilling rig subject to rig motion;
a processor communicatively coupled to the at least one sensor; and
a non-transitory memory device comprising instructions that are executable by the processor to cause the processor to perform operations comprising:
receiving, in real time from the at least one sensor, a position signal indicative of the rig motion;
applying a state observer to the position signal to determine annular flow parameters;
modeling an annular flow for a wellbore associated with the drilling rig to produce a modeled flow signal based on the annular flow parameters, the modeled flow signal reflecting a position of the drilling rig relative to influx flow;
determining kick-loss-alarm parameters from the modeled flow signal; and
applying the kick-loss-alarm parameters to an alarm module.

2. The system of claim 1, wherein the at least one sensor comprises a heave motion sensor and the rig motion comprises wave-induced rig motion.

3. The system of claim 1, wherein the operation of modeling the annular flow further comprises:
applying a linear quadratic estimation filter to the position signal to estimate a velocity of the rig motion in a state vector and to estimate an influx flow variation; and
optimizing a gain of the state observer based on the velocity of the rig motion and the influx flow variation.

4. The system of claim 1, wherein the operation of determining the kick-loss-alarm parameters comprises adjusting an alarm threshold for at least one of kick or loss based on the rig motion as determined from the modeled flow signal.

5. The system of claim 4, further comprising a display device, and wherein the operations further comprise:
determining a standard deviation from a statistical distribution of influx flow variation;
calculating a confidence level for the alarm threshold based on the standard deviation; and
displaying the confidence level on a display device.

6. The system of claim 1, wherein the operation of modeling the annular flow further comprises producing a physics-based model based on a pumping effect of a telescope joint, annulus fluid return, and mass conservation.

7. The system of claim 1, wherein the operation of modeling the annular flow further comprises producing a machine-learning model that determines, based on the position signal over time, an annular area and a bias term quantifying pumping efficiency.

8. A method comprising:
receiving, by a processing device in real time from at least one sensor, a position signal indicative of rig motion;
applying, by the processing device, a state observer to the position signal to determine annular flow parameters;
modeling, by the processing device, an annular flow for a wellbore to produce a modeled flow signal based on the annular flow parameters, the modeled flow signal reflecting a position of a drilling rig relative to influx flow;
determining, by the processing device, kick-loss-alarm parameters from the modeled flow signal; and
applying, by the processing device, the kick-loss-alarm parameters to an alarm module.

9. The method of claim 8, wherein the at least one sensor comprises a heave motion sensor and the rig motion comprises wave-induced rig motion.

10. The method of claim 8, wherein modeling the annular flow further comprises:
applying a linear quadratic estimation filter to the position signal to estimate a velocity of the rig motion in a state vector and to estimate influx flow variation; and
optimizing a gain of the state observer based on the velocity of the rig motion and the influx flow variation.

11. The method of claim 8, wherein determining the kick-loss-alarm parameters comprises adjusting an alarm threshold for at least one of kick or loss based on the rig motion as determined from the modeled flow signal.

12. The method of claim 11 further comprising:
determining a standard deviation from a statistical distribution of influx flow variation;
calculating a confidence level for the alarm threshold based on the standard deviation; and
displaying the confidence level on a display device.

13. The method of claim 8, wherein modeling the annular flow further comprises producing a physics-based model based on a pumping effect of a telescope joint, annulus fluid return, and mass conservation.

14. The method of claim 8, wherein modeling the annular flow further comprises producing a machine-learning model that determines, based on the position signal over time, an annular area and a bias term quantifying pumping efficiency.

15. A non-transitory computer-readable medium that includes instructions that are executable by a processor for causing the processor to perform operations related to kick and loss detection, the operations comprising:
receiving, in real time from at least one sensor, a position signal indicative of rig motion;
applying a state observer to the position signal to determine annular flow parameters;
modeling an annular flow for a wellbore to produce a modeled flow signal based on the annular flow parameters, the modeled flow signal reflecting a position of a drilling rig relative to influx flow;
determining kick-loss-alarm parameters from the modeled flow signal; and
applying the kick-loss-alarm parameters to an alarm module.

16. The non-transitory computer-readable medium of claim 15, wherein the operation of modeling the annular flow further comprises:
applying a linear quadratic estimation filter to the position signal to estimate a velocity of the rig motion in a state vector and to estimate an influx flow variation; and
optimizing a gain of the state observer based on the velocity of the rig motion and the influx flow variation.

17. The non-transitory computer-readable medium of claim 15, wherein the operation of determining the kick-loss-alarm parameters comprises adjusting an alarm threshold for at least one of kick or loss based on the rig motion as determined from the modeled flow signal.

18. The non-transitory computer-readable medium of claim 17, wherein the operations further comprise:
determining a standard deviation from a statistical distribution of influx flow variation;
calculating a confidence level for the alarm threshold based on the standard deviation; and
displaying the confidence level on a display device.

19. The non-transitory computer-readable medium of claim 15, wherein the operation of modeling the annular flow further comprises producing a physics-based model based on a pumping effect of a telescope joint, annulus fluid return, and mass conservation.

20. The non-transitory computer-readable medium of claim 15, wherein the operation of modeling the annular flow further comprises producing a machine-learning model that determines, based on the position signal over time, an annular area and a bias term quantifying pumping efficiency.
